(19) United States
(12) Patent Application Publication
(10) Pub. No.: US 2019/0158652 A1
(43) Pub. Date: May 23, 2019

(54) DISTRACTED DRIVING SMARTPHONE LOCK BOX SYSTEM

(71) Applicant: Charles Isgar, Scottsdale, AZ (US)

(72) Inventor: Charles Isgar, Scottsdale, AZ (US)

(21) Appl. No.: 16/005,574

(22) Filed: Jun. 11, 2018

Related U.S. Application Data
(60) Provisional application No. 62/587,955, filed on Nov. 17, 2017.

(51) Int. Cl. H04M 1/725; H04W 4/80; H04M 1/60; B60Q 9/00

(52) U.S. Cl. CPC H04M 1/72577; H04W 4/80; B60Q 9/00; H04M 1/6075; H04M 1/7253

(57) ABSTRACT

Described is a vehicle smartphone lock box system that is used to limit access to a mobile computing device while driving. The vehicle smartphone lock box system includes a box with a lid that is designed to contain one or more mobile computing devices such as smartphones or tablets. The box is placed inside a vehicle and communicates with the vehicle. A mobile computing device put in the box cannot be accessed while driving. The box senses when a mobile computing device is in the box. The box communicates with the mobile computing device and the vehicle electronics to record when a mobile computing device is in the box and when the vehicle is moving.

### CROSS REFERENCE TO RELATED APPLICATION[S]

This application claims priority to U.S. Provisional Patent Application entitled “VEHICLE SMARTPHONE LOCK BOX SYSTEM,” Ser. No. 62/587,955, filed Nov. 17, 2017, now pending, the disclosure of which is hereby incorporated entirely herein by reference.

### BACKGROUND OF THE INVENTION

### Technical Field

This invention relates to smartphone accessories, and specifically to a container in a vehicle for securing a smartphone within to limit physical access to the smartphone while driving.

### State of the Art

Cellular phones are a significant cause of distracted driving. The following statistics highlight the increasingly dangerous national safety concern of texting while driving on American roads and highways:
a. 1 out of every 4 traffic crashes that occur in the U.S. are caused by cell phone usage;
b. Each day in the U.S., approximately 9 people are killed and more than 1,000 are injured in crashes reported to involve a distracted driver;
c. The chances of a crash because of any reason is increased by 23 times when you are texting; and
d. An NHTSA survey showed that only 1 in 5 teens believes that texting impacts their personal driving performance.
   It is generally recognized that cell phone use and driving is dangerous, but the urge to check messages, emails and modern apps as evidenced is very addictive when the phone is available to the driver.

Accordingly, what is needed is a container in a vehicle for securing a mobile computing device so that it cannot be physically accessed while driving, helping avoid the temptation to glance at the screen of the mobile computing device even for a second.

### DISCLOSURE OF THE INVENTION

The disclosed invention relates to smartphone accessories, and specifically to a box in a vehicle for securing a smartphone into so that the smartphone cannot be physically accessed by the user with his or her hands while driving.

An embodiment includes a vehicle smartphone lock box system comprising: a securing container, wherein the securing container holds a mobile computing device, and wherein the securing container is coupled to a vehicle; a microcomputer integrated into the securing container, wherein the microcomputer is communicatively coupled to the mobile computing device and receives information from a lockbox application running on the mobile computing device; and a sensor that senses when the mobile computing device is in the securing container.

Another embodiment includes a vehicle smartphone lock box system comprising: a smartphone securing container, wherein the securing container holds a smartphone, and wherein the securing container is coupled to a vehicle; a sensor integrated into the securing container that senses when the smartphone is in the securing container; and an application operating on the smartphone, wherein the lockbox application running on the mobile computing device executes instructions to automatically send data regarding a time the smartphone is placed the securing container in response to the sensor sensing the smartphone is in the securing container.

Another embodiment includes a vehicle smartphone lock box system comprising: securing container, wherein the securing container holds a mobile computing device, and wherein the securing container is coupled to a vehicle; a microcomputer integrated into the securing container, wherein the microcomputer is communicatively coupled to the mobile computing device and receives information from a lock box application running on the mobile computing device; a sensor that senses when the mobile computing device is in the securing container; and an ignition connection, wherein the securing container is coupled to the ignition by the ignition connection to limit starting of the vehicle only to when the mobile computing device of a driver is placed within the securing container.

The foregoing and other features and advantages of the invention will be apparent to those of ordinary skill in the art from the following more particular description of the invention and the accompanying drawings.

### BRIEF DESCRIPTION OF THE DRAWINGS

FIG. 1 is a perspective view of a vehicle smartphone lock box system according to an embodiment;

FIG. 2 is a perspective view of a vehicle smartphone lock box system with the lock box open according to an embodiment;

FIG. 3 is another perspective view of a vehicle smartphone lock box system according to an embodiment;

FIG. 4 is a perspective view of a vehicle smartphone lock box system within a vehicle according to an embodiment;

FIG. 5 is another perspective view of a vehicle smartphone lock box system within a vehicle according to an embodiment;

FIG. 6 is a perspective view of a vehicle smartphone lock box system integral a vehicle according to an embodiment;

FIG. 7 is a perspective view of a vehicle smartphone lock box system integral a vehicle with the lock box open according to an embodiment;

FIG. 8 is another perspective view of a vehicle smartphone lock box system integral a vehicle with the lock box open according to an embodiment;

FIG. 9 is a perspective view of a vehicle smartphone lock box system integral a vehicle and connected to the vehicle electronics system according to an embodiment; and

FIG. 10 shows a block diagram of a vehicle smartphone lock box system according to an embodiment.

### DETAILED DESCRIPTION OF EMBODIMENTS OF THE INVENTION

As discussed above, embodiments of the present invention relate to smartphone accessories, and specifically to a box in a vehicle for securing a smartphone into so that the smartphone cannot be accessed while driving.

Disclosed is a vehicle smartphone lock box system that is used to contain a mobile computing device in a vehicle so that the mobile computing device cannot be accessed while the vehicle is running. It is dangerous to use a mobile computing device while driving, but too many people still engage in this activity. The vehicle smartphone lock box system includes a box for securing a mobile computing device such as a smartphone or tablet into. The vehicle smartphone lock box system can be used by individuals to keep them from using their smartphone or other mobile computing device while driving. The vehicle smartphone lock box system records and reports when the mobile computing device is secured in the container and when the vehicle is moving. Individuals can use the vehicle smartphone lock box system to discipline their smartphone use while driving, in order to help drivers to use their smartphone or cellular phones in a handsfree manner as opposed to being distracted by driving when operating the smartphone with the driver's hands.

Supervising individuals, such as, but not limited to, parents, employers, supervisors and the like, can use the vehicle smartphone lock box system to incentivize an individual to use their mobile computing device with his or her hands while driving. for example, the smartphone lock box system may be utilized with a point system in order for users to accumulate points by usage of the lock box and earn rewards or exchange points for rewards. The vehicle smartphone lock box system helps discipline young motorists to stop using their smartphones in a non-handsfree mode while driving. The vehicle smartphone lock box system may communicate with the vehicle electronics system and records vehicle and smartphone status data while driving. This and other data may be collected and utilized, such as use by insurance companies to provide a discount to insurance rates for safe driving or the like, particularly for teen drivers.

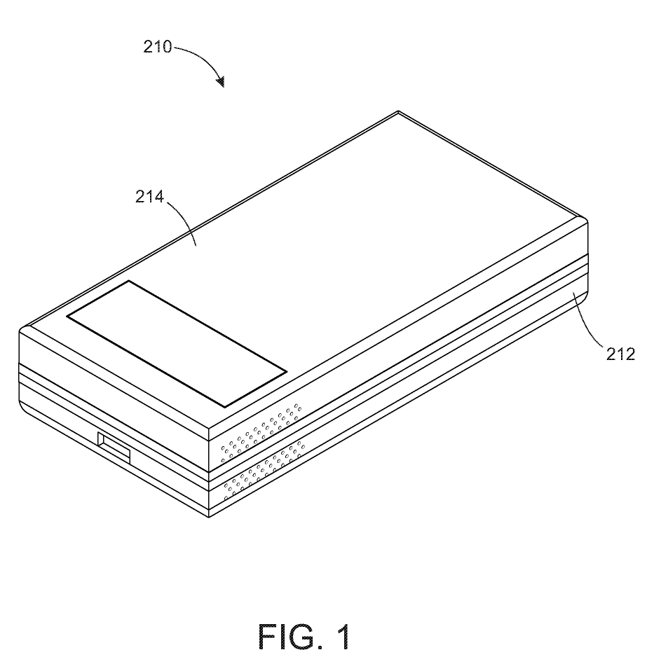

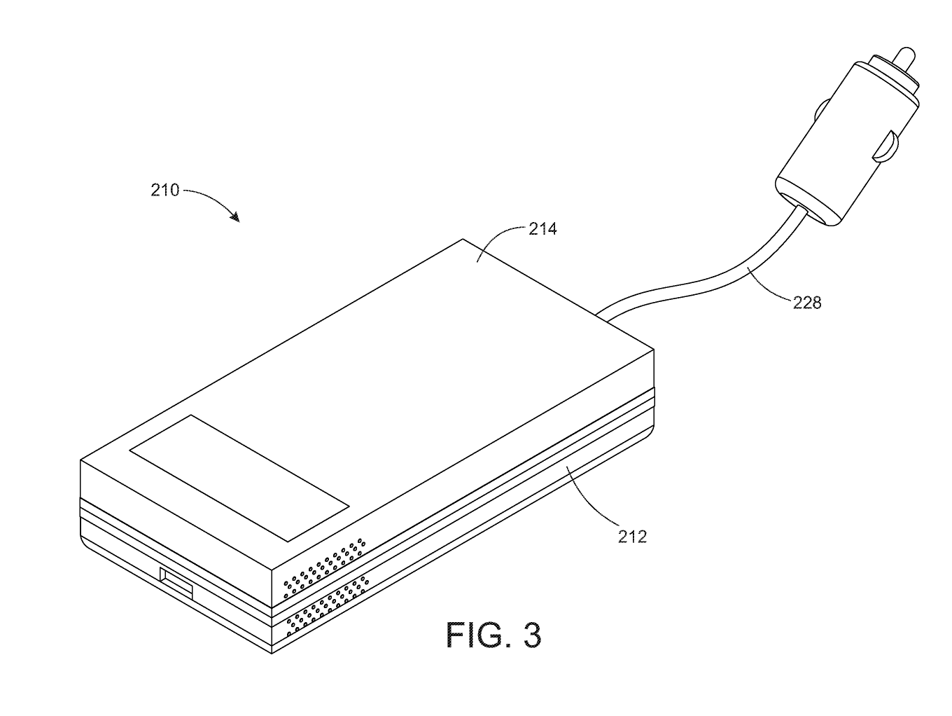

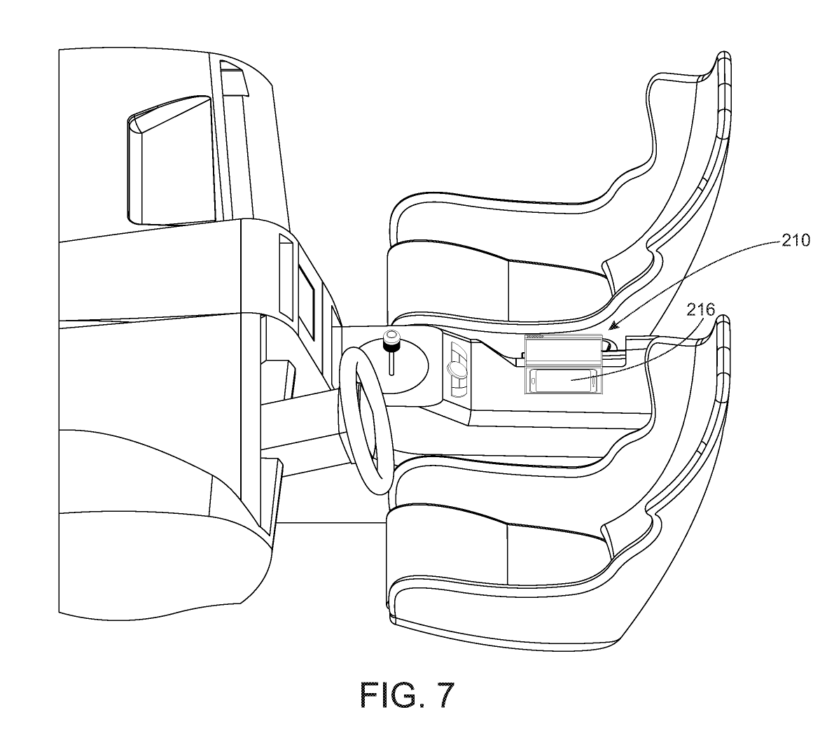

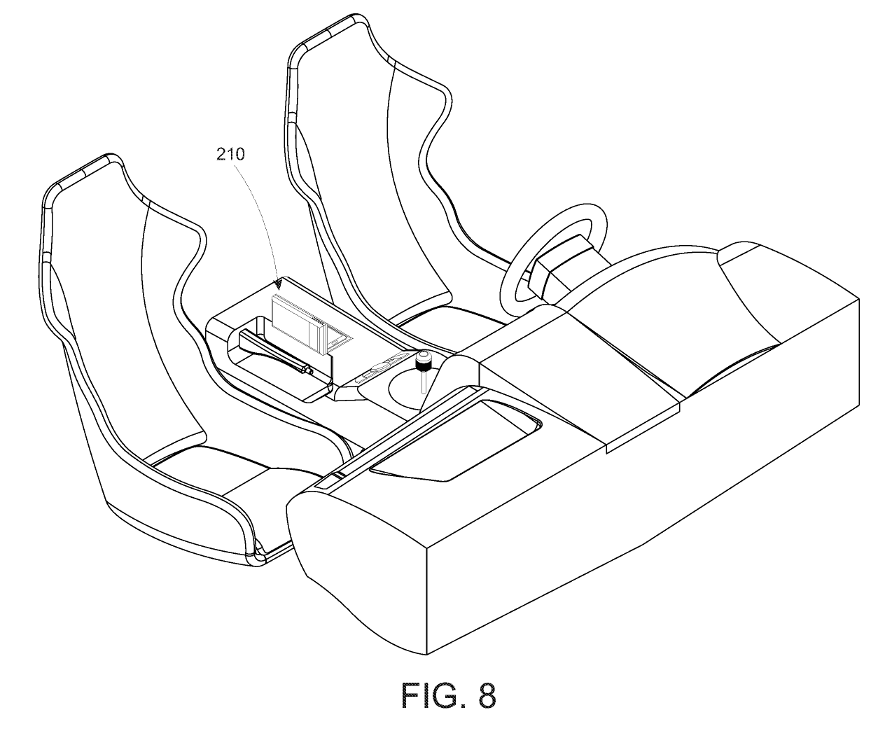

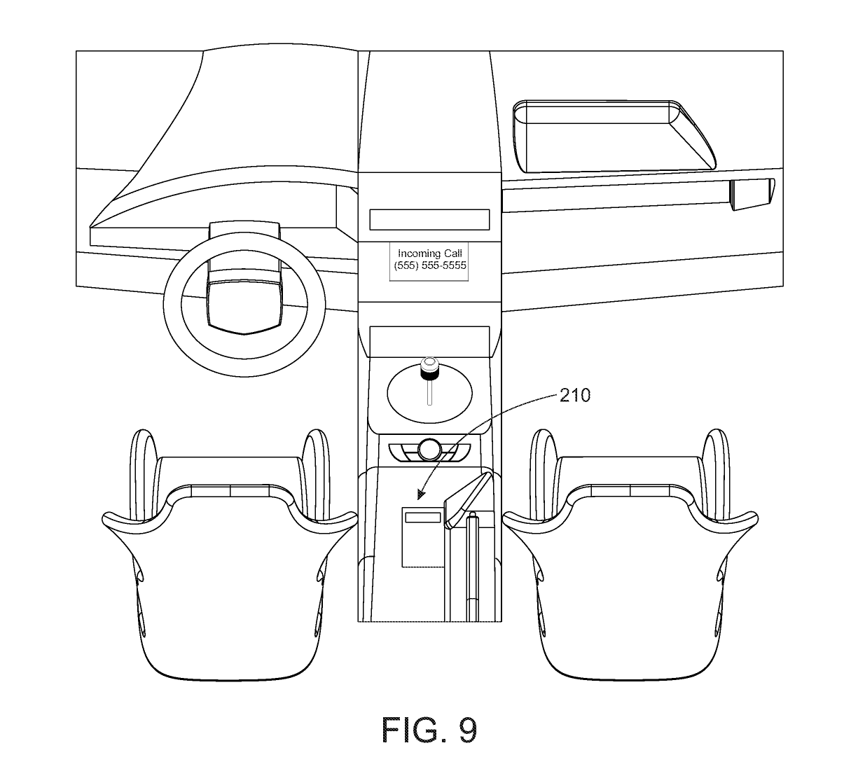

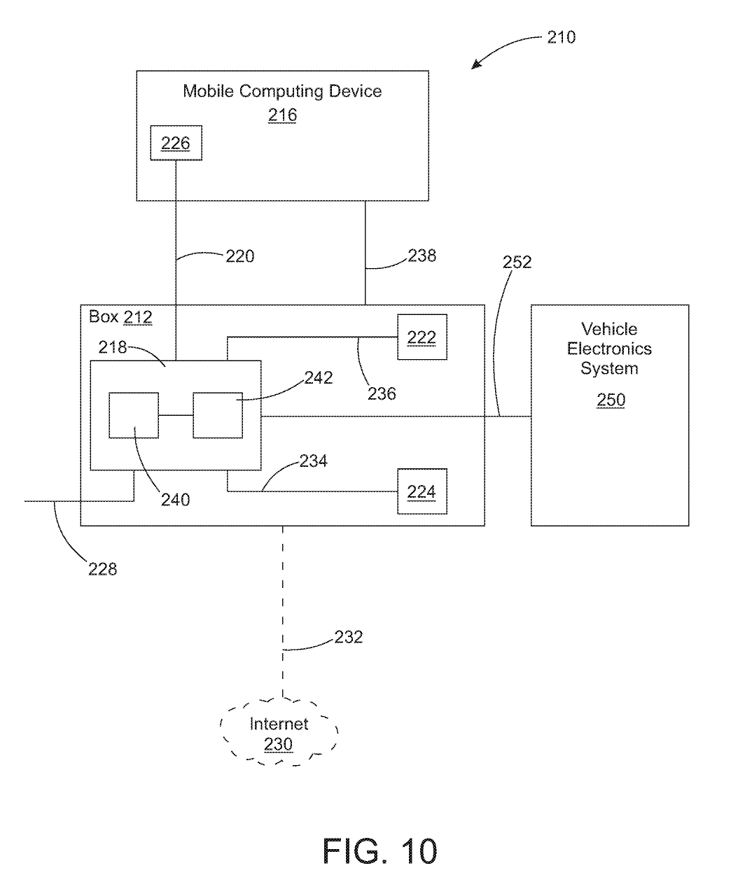

FIGS. 1-10 show embodiments of a vehicle smartphone lock box system 210. Vehicle smartphone lock box system 210 is used to lock a smartphone or other mobile computing device into a box so that the smartphone cannot be accessed while driving. The vehicle smartphone lock box system can be used by individuals, parents, employers, police departments or others who wish to teach and instill discipline into mobile computing device use while driving.

Vehicle smartphone lock box system 210 includes a container 212 with a lid 214. Container 212 is designed to contain a mobile computing device 216. Lid 214 locks onto container 212 so that mobile computing device 216 cannot be accessed while it is secured in container 212. Container 212 is mounted in a vehicle 254 and connected to a vehicle electronics system 250 of vehicle 254. Container 212 has a microcomputer 218 integrated into container 212. Microcomputer 218 is communicatively coupled to a lock box software application 226 running on mobile computing device 216. Microcomputer 218 is communicatively coupled to lock box application 226 using a communication link 220. Microcomputer 218 is also communicatively coupled to a vehicle electronics system 250 of vehicle 254 using a communication link 252. This allows the smartphone to interact with the vehicle internal display in order to perform certain operations with the phone without the need of handling or physically accessing the phone. Lock box application 226 runs on mobile computing device 216 to communicate with container 212 and control smartphone lock box system 210. Container 212 has a sensor 222 that senses when mobile computing device 216 is inside container 212.

Mobile computing device 216 can be any type of mobile device with computing capability, such as a smartphone, a cellular telephone, a mobile computer, a computing tablet or pad, or any other device that can be mobile and has computing capabilities. Mobile device 216 is a smartphone in the embodiment shown in the figures, but this is not meant to be limiting. Additionally, the container 112 may be any type of retaining unit, such as a box (as shown in the drawings), a sleeve, a locker, a pouch and the like, that provides a physical barrier to access of the mobile computing device 216.

Mobile computing device 216 has a lock box application 226 loaded onto mobile computing device 216, in this embodiment. Lock box application 226 is communicatively coupled to microcomputer 218 of container 212 using communication link 220. Communication link 220 is a wireless communication link is this embodiment, but can be a wired communication link. Lock box application 226 controls vehicle smartphone lock box system 210 and interfaces with microcomputer 218 and vehicle electronics system 250. Lock box application 226 is a software application in this embodiment, but this is not meant to be limiting. While mobile computing device 216 is secured in container 212, lock box application 226 can send specific approved messages or information to vehicle electronics 250 so the messages are displayed on the vehicle display system.

According to particular embodiments, communication link 220 may be a Near Field Communication (“NFC”) link. NFC is related to radio-frequency identification (RFID) with the exception that NFC is designed for use by devices within close proximity to each other. Devices using NFC may be active or passive. A passive device has information that is readable by other devices; however, the passive device cannot read information of another device. Active devices can read and send information. An example of an active device is a smartphone. In active NFC, each device is active and when a device sends data it generates an RF field and when waiting the device does not generate an RF field. In other words, the RF field is alternately generated by each device. In passive NFC, the RF field is only generated by one device. NFC devices may also provide secure communication by using a secure channel and encryption when sending sensitive information.

In general, there are three current signaling technologies for NFC devices to talk to each other. These signaling technologies are referred to as NFC-A, NFC-B and NFC-F. When devices first communicate, they communicate the signal type and then transmit data in compliance with the specified protocol.

NFC-A corresponds with RFID Type A communication. In Type A communication, Miller encoding is used with amplitude modulation at 100 percent. A signal sent between devices must change from 0 to 100 percent to register the difference between sending a “1” and a “0.” Data is transmitted at 106 Kbps when using Type A communication.

Similar to NFC-A, NFC-B corresponds with RFID Type B communication. Type B uses Manchester encoding. Amplitude modulation is at 10 percent, wherein a 10 percent change from 90% for low to 100% for high is used. A change from low to high represents a “0” while high to low represents a “1.”

NFC-F refers to a faster form of RFID transmission known as FeliCa. FeliCa is a technology similar to NFC but faster and currently more popular. It is used for a variety of services such as subway tickets, credit card payments, and identification at office buildings and other locations with limited access.

The system 210 may utilize various types of NFC communication, including active or passive NFC, as well as using various types of signals. The NFC would provide close proximity communication between the mobile computing device 216 and the lock container 212 only when the mobile computing device 216 is placed within the container 212.

Container 212 is designed to hold mobile computing device 216. Container 212 may have a lid 214 that will lock mobile computing device 216 in container 212. However, in some embodiments, the locking lid is a sensor lid that determines if a phone is located in the box and the lid is closed. Having mobile computing device 216 being secured in container 212 in vehicle 254 means that the user of mobile computing device 216 cannot access, pick up, or use mobile computing device 216 while it is in container 212. Mobile computing device 216 is put in container 212 while vehicle 254 is being driven so that the driver cannot pick up and use mobile computing device 216 while driving vehicle 254. Container 212 can be made in different sizes for different mobile computing device sizes. In some embodiments, container 212 is made large enough to hold multiple mobile computing devices 216. Vehicle smartphone lock box system 210 may be integrated into a vehicle at the factory, or added later by the owner.

Microcomputer 218 is integrated into container 212 to provide container 212 with computing and communication ability. Microcomputer 218 includes a microprocessor 240 and memory 242 in this embodiment, but this is not meant to be limiting. Microcomputer 218 can include many types of computing hardware and software to give container 212 computing and communications capability. Microcomputer 218 is communicatively coupled to lock box app 226 of mobile computing device 216 using communication link 220.

Microcomputer 218 is communicatively coupled to vehicle electronics system 250 using communication link 252. Lockbox app 226, microcomputer 218 and vehicle electronics system 250 communicate to record when mobile computing device 216 is in container 212, to record when vehicle 254 is in motion, and any other data that it may be desirable to track to monitor the use of mobile computing device 216 in vehicle 254. In some embodiments, lock box app 226 is programmed to send specific types of messages, phone calls and other data to vehicle electronics system 250 so that a user of vehicle smartphone lock box system 210 can still interact with mobile phone 216 while mobile phone 216 is in container 212. This communication must be routed through vehicle electronics 250, and is monitored and recorded by lock box app 226 and microcomputer 218. In some embodiments, lock box app 226 is programmed to send only emergency communications to vehicle electronics system 250. In some embodiments, lock box app 226 is programmed to send no communications to vehicle electronics system 250. Either lock box app 226 or microcomputer 218 can record data such as how long mobile computing device 216 is in container 212, when vehicle 254 was in motion, what communications, if any occurred between mobile computing device 216 and vehicle electronics 250, and many other types of data.

Container 212 includes a sensor 222 that senses when mobile computing device 216 is in container 212. Sensor 222 can be and NFC sensor, a Bluetooth™ sensor or any other type of sensor that can determine when mobile computing device 216 is in container 212. Sensor 222 is communicatively coupled to microcomputer 218 using a communication link 236, which can be wired or wireless.

Lid 214 of container 212 may have a display 224 mounted to the outside of lid 224 so that display 224 can be viewed when container 212 is closed. Display 224 may be a large display or larger than the smartphone screen and can be used to display information related to mobile computing device 216 and vehicle smartphone lock box system 210. When mobile computing device 216 is secured in container 212, display 224 can show the amount of time that mobile computing device 216 has been in container 212. Display 224 is communicatively coupled to microcomputer 218 using a communication link 234. Display 224 can display information from mobile computing device 216. For example, mobile computing device 216 and lock box app 226 can be programmed to send messages from certain individuals to display 224, or other important or emergency information, instead of, or in addition to, sending the information to vehicle electronics system 250 for display on a vehicle display. There may be messages or contacts that have priority status, and this information can be set to be sent to display 224 while mobile computing device 216 is in container 212, so that the user can see these priority messages. In some embodiments, display 224 is not on lid 214, but is mounted to container 212 in some other position besides on lid 214.

Container 212 receives power from a power cable 228. Power cable 228 can be plugged into wall power when vehicle smartphone lock box system 210 is not in use in vehicle 254. Alternatively, power cable 228 can be plugged into a vehicle power source when vehicle smartphone lock box system 210 is in vehicle 254. Mobile computing device 216 can be charged while in container 212 using a power connection 238 between container 212 and mobile computing device 216.

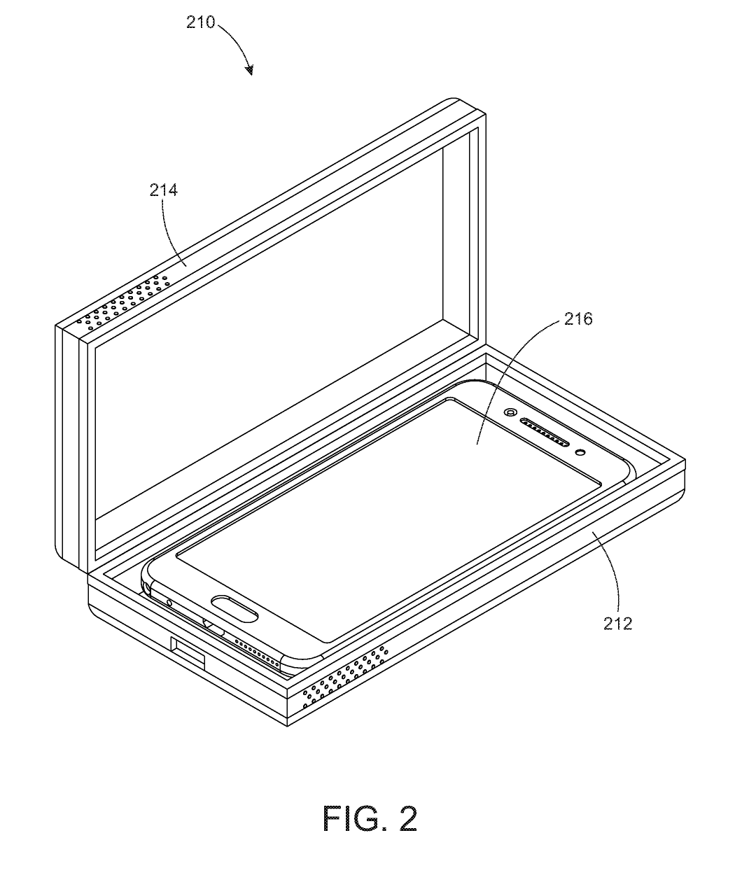

In some embodiments, container 212 is communicatively coupled to the internet 230 using a communication link 232. Internet 230 and link 232 are shown in dotted lines in FIG. 2 to indicate they are optional features. Container 212 can communicate with internet 230 for many different reasons. In some embodiments, container 212 is coupled to internet 230 through vehicle electronics system 250. In some embodiments, parents can track whether their children's mobile computing device 216 is in container 212 while the child is driving, using internet connection 232. In some embodiments, the time that mobile computing device 216 is secured in container 212 is reported to parents, social media, employers, or other groups or individuals through internet 230. Further still, in embodiments, if the vehicle begins traveling and the mobile computing device 216 is not secured in container 212, the system 210 operates to send an alert to supervising device of a supervising individual, such as a parent, an employer, a teacher and the like. The supervising individual may then reach out to the driver and request the mobile computing device 216 be put into the container 212.

Vehicle smartphone lock box system 210 is used to keep an owner of mobile computing device 216 from accessing and using mobile computing device 216 while the owner is driving vehicle 254. Drivers of all ages need to resist using their mobile computing devices while driving. Vehicle smartphone lock box system 210 helps individuals disconnect from their technology while driving, and provides a way to track the amount and timing of disconnect. Container 212 makes mobile computing device 216 not accessible when mobile computing device 216 is secured in container 212. Container 212 uses sensor 222 to sense when mobile computing device 216 is in container 212. Microcomputer 218 of container 212 communicates with mobile computing device 212, lock box application 226, sensor 222, and vehicle electronics system 250 to track and report the times and periods that mobile computing device 216 is in container 212 and when vehicle 254 is in motion. One way this can be accomplished is with a motion sensor coupled within the container 212. Individuals can use vehicle smartphone lock box system 210 to disconnect themselves from mobile computing device 216 while driving. Parents can use vehicle smartphone lock box system 210 to monitor and understand their children's use of mobile computing device 216 when the child is driving. Vehicle smartphone lock box system 210 can be used by parents to track and record a child's use of mobile computing device 216 while driving. Vehicle smartphone lock box system 210 can be used by parents, teachers, students, employers, or any other individual or group to limit access to mobile computing device 216 while driving.

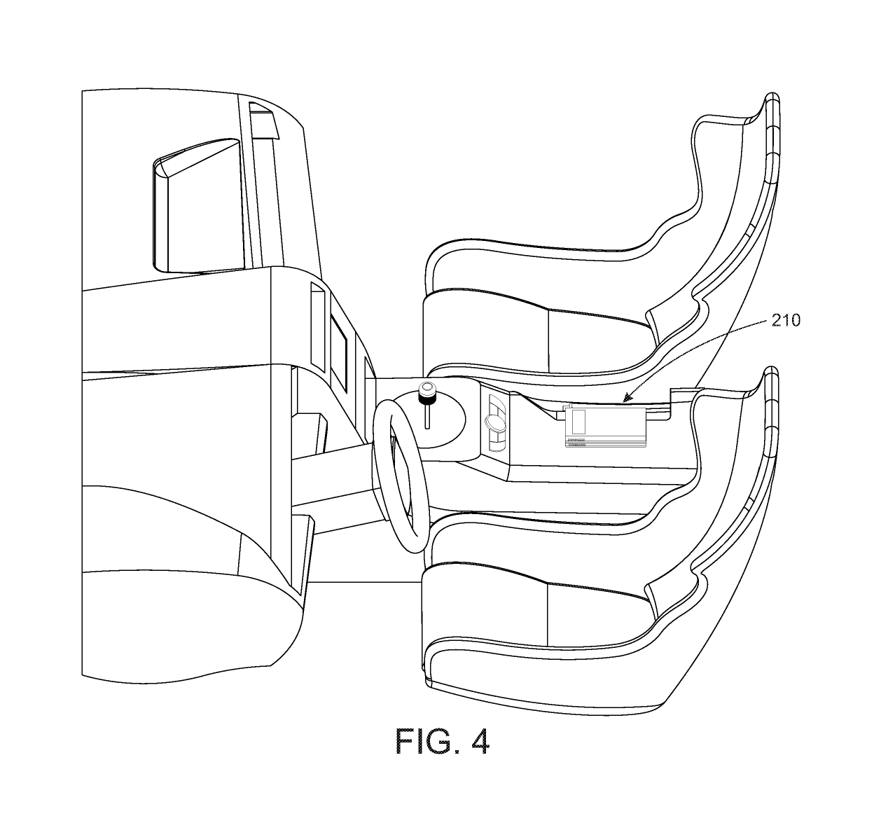

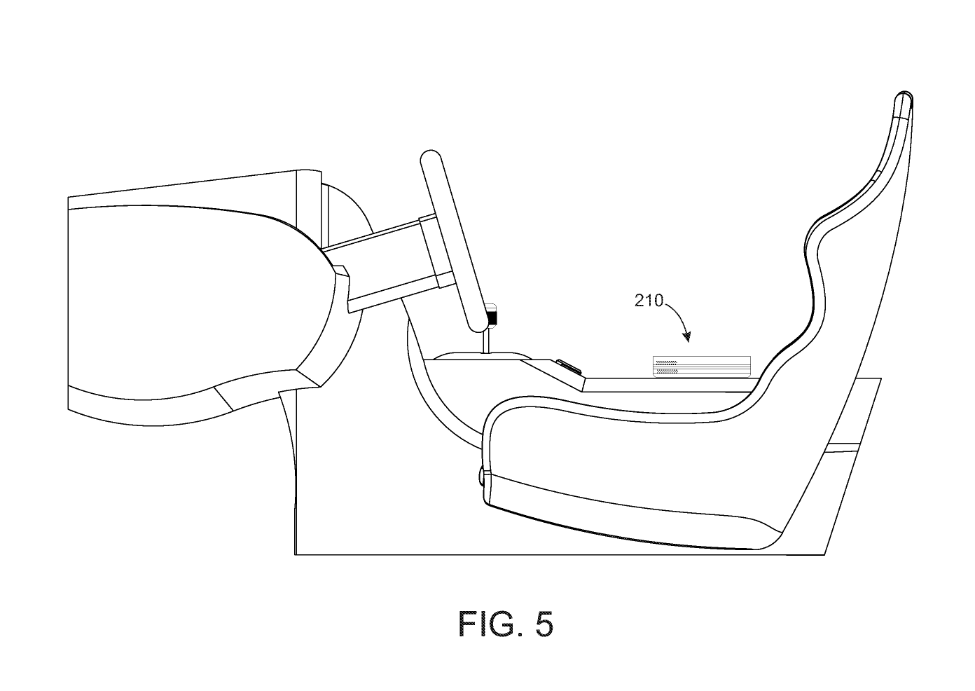

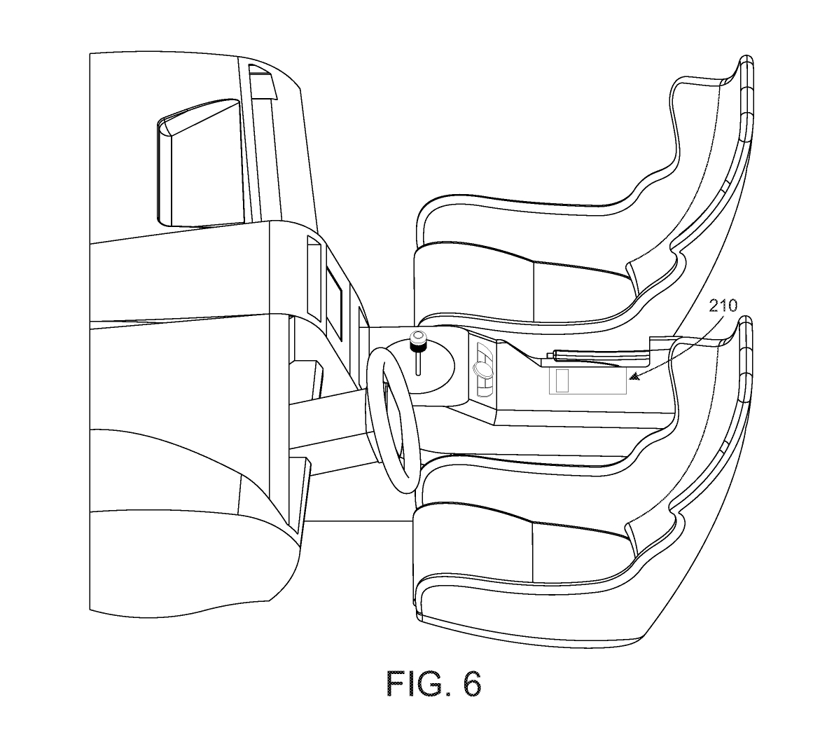

In some embodiments, as shown in FIGS. 4-5, the container 212 of the vehicle smartphone lock box system 210 may be a portable container that is usable in any vehicle. In other embodiments, as shown in FIGS. 6-9, the container 212 of the vehicle smartphone lock box system 210 may be manufactured with a container 212 integral with the vehicle, such as formed as part of a middle console or the like. This integral container 212 operates in a manner as described above with regard to the container 212 of the vehicle smartphone lock box system 210.

Further, mobile computing device 216 operating the lock box application 226 may send an alert to supervising device of a supervising individual, such as a parent, an employer, a teacher and the like. The supervising individual may then reach out to the driver and request the mobile computing device 216 be put into the container 212. Further still, the mobile computing device operating the lock box application 226 may record data, such as time within the container 212 during driving and record it to a server or other storage for later generation of reports. In particular, insurance companies may access the system 210 in order to generate reports, or report directly to the insurance company regarding the usage of smartphones 216 of an insured driver with the insurance company in order to see how the insured driver uses his or her smartphone 216 during operation of his or her vehicle. The report may be utilized to determine what, if any, discount can be given to the insured driver for placing his or her smartphone 216 within the container 212 during driving.

Further still, embodiments of the present invention may include a vehicle smartphone lock box system 210 includes a container 212 such as a box, a pouch, a pop up container and the like. Container 212 is designed to contain a mobile computing device, such as a smartphone 216. Container 212 operates keep the smartphone 216 from being accessed while it is located in container 212. Container 212 is mounted in a vehicle 254. The smartphone 216 may operate a lock box application 229 and may be connected to a vehicle electronics system 250 of vehicle 254. This allows the smartphone 216 to interact with the vehicle internal display in order to perform certain operations with the phone 216 without the need of handling or physically accessing the phone. Lock box application 229 runs on mobile computing device 216 to communicate with container 212 and control smartphone lock box system 210. Container 212 has a sensor 222 that senses when smartphone 216 is inside container 212.

Smartphone 216 has the lock box application 229 loaded onto smartphone 216, in this embodiment. Lock box application 229 controls vehicle smartphone lock box system 210 and interfaces with the vehicle electronics system 250. Lock box application 229 is a software application in this embodiment, but this is not meant to be limiting. While smartphone 216 is located within container 212, lock box application 229 can send specific approved messages or information to vehicle electronics 250 so the messages are displayed on the vehicle display system and also allowing the driver to operate the smartphone 216 in a handsfree manner.

The smartphone 216 further comprises accelerometers, a GPS device or a combination of the accelerometers and the GPS device to determine whether the smartphone is in the vehicle as the vehicle is driven. The lock box application 229 operating on the smartphone 216 further reports that smartphone 216 is within the container 212 as the vehicle is traveling in response to the sensor sensing the smartphone 216 is in the container 212 and the smartphone has determined the vehicle is being driven. The lock box application 229 operating on the smartphone 216 provides instruction to automatically send a report to the server for storage that the smartphone 216 is not within the container 212 as the vehicle is driven and further, the lock box application 229 operating on the smartphone 216 provides instruction to send an alert to a supervising device in response to the vehicle traveling without the mobile computing device within the box.

The vehicle smartphone lock box system of claim 12, wherein the smartphone is communicatively coupled to a vehicle electronics system for handsfree operation of the smartphone.

It should also be appreciated that companies and other entities that may have company cars or fleet cars may utilize the lock box system as described above for fleet management purposes to ensure drivers of company vehicles are reducing distractions during the driving of company or fleet vehicles. The data collected from the lock box system may be collected, stored on a server and analyzed by the company in order to ensure safe handsfree usage of smartphones by the drivers and make correction or provide some type of incentive for proper use of the lock box system.

Further, the operation of a driver's own vehicle for employment purposes may include the use of a lock box system. These may include a portable container 212 that can be removably coupled to the driver's vehicle. This would operate to send data to a server for storage and later analysis on the driver's handsfree use of a smartphone while driving.

In another embodiment, the lock box system 210 may operate as discussed above, however, it may include the container 212 coupled to vehicle as an interlock device wherein the container 212 is wired to the ignition of the vehicle with an ignition connection, wherein the vehicle cannot start unless the mobile computing device 216 is placed within container 212. In these embodiments, once the mobile computing device 216 is placed within the container 212, the box completes the ignition circuit to allow the vehicle to start properly. The system 210 may continuously check or monitor the mobile computing device 216 to ensure it remains in the container 212 during the entire travel time. In other embodiments, the sensor may operate to sense if the mobile computing device 216 is removed from the container 212 during operation of the vehicle.

In these embodiments where the lock box system 210 operates as an interlock device, parent may optionally install this type of lock box on a teen driver vehicle to limit the operation of the vehicle to only those times that the teen puts his or her mobile computing device 216 within the container 212. Further, the system 210 operating as an interlock device may be installed based on court order that requires a driver to place his or her mobile computing device 216 within the container 212 based on driving record, negligent driving citations based on smartphone usage while driving and the like.

Embodiments may be available on or through the internet, such as through domain names reserved and owned by Applicant that include goodbyedistractions.com or the like.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A vehicle smartphone lock box system comprising:
a securing container, wherein the securing container holds a mobile computing device, and wherein the securing container is coupled to a vehicle;
a microcomputer integrated into the securing container, wherein the microcomputer is communicatively coupled to the mobile computing device and receives information from a lockbox application running on the mobile computing device; and
a sensor that senses when the mobile computing device is in the securing container.

2. The vehicle smartphone lock box system of claim 1, wherein the microcomputer is communicatively coupled to a vehicle electronics system.

3. The vehicle smartphone lock box system of claim 1, wherein the microcomputer of the securing container is communicatively coupled to the mobile computing device with an NFC link.

4. The vehicle smartphone lock box system of claim 1, wherein the securing container is communicatively coupled to the internet.

5. The vehicle smartphone lock box system of claim 1, wherein the securing container further comprises a power cord that supplies power to the smartphone lock box system when the power cord is coupled to a power source of the vehicle.

6. The smartphone lock box system of claim 5, wherein the securing container further comprises a charging device coupled to the power cord, whereby the mobile computing device may be recharged while removably coupled to the charging device.

7. The smartphone lock box system of claim 1, wherein the securing container is portable for use in any vehicle.

8. The smartphone lock box system of claim 1, wherein the securing container is integral with the vehicle.

9. The smartphone lock box system of claim 1, wherein the system sends an alert to a supervising device in response to the vehicle traveling without the mobile computing device within the securing container.

10. The vehicle smartphone lock box system of claim 1, further comprising a display wherein the display is at least one indicator light, wherein the at least one indicator light is illuminated in response to changes in a status of the lock box system.

11. The vehicle smartphone lock box system of claim 1, further comprising a display wherein the display is a screen that displays information from the mobile computing device.

12. A vehicle smartphone lock box system comprising:
a smartphone securing container, wherein the securing container holds a smartphone, and wherein the container is coupled to a vehicle;
a sensor integrated into the securing container that senses when the smartphone is in the securing container; and
an application operating on the smartphone, wherein the application running on the mobile computing device executes instructions to automatically send data regarding a time the smartphone is placed the securing container in response to the sensor sensing the smartphone is in the securing container.

13. The vehicle smartphone lock box system of claim 12, wherein the smartphone further comprises accelerometers, a GPS device or a combination of the accelerometers and the GPS device to determine whether the smartphone is in the vehicle as the vehicle is driven.

14. The vehicle smartphone lock box system of claim 13, wherein the application operating on the smartphone further reports that smartphone is within the securing container as the vehicle is traveling in response to the sensor sensing the smartphone is in the securing container and the smartphone has determined the vehicle is being driven.

15. The vehicle smartphone lock box system of claim 13, wherein the application operating on the smartphone provides instruction to automatically send a report to the server for storage that the smartphone is not within the securing container as the vehicle is driven.

16. The smartphone lock box system of claim 13, wherein the application operating on the smartphone provides instruction to send an alert to a supervising device in response to the vehicle traveling without the smartphone within the securing container.

17. The vehicle smartphone lock box system of claim 12, wherein the smartphone is communicatively coupled to a vehicle electronics system for handsfree operation of the smartphone.

18. The vehicle smartphone lock box system of claim 13, wherein the microcomputer further comprises:
a microprocessor integrated into the microcomputer; and
a memory communicatively coupled to the microprocessor.

19. (canceled)

20. (canceled)

21. The vehicle smartphone lock box system of claim 12, wherein the securing container comprises a lid and the sensor further senses that the lid is closed.
